(19) United States
(12) Patent Application Publication
(10) Pub. No.: US 2019/0335736 A1
(43) Pub. Date: Nov. 7, 2019

(54) HAND NET YOKE

(71) Applicant: Plano Molding Company, Plano, IL (US)

(72) Inventors: Timothy S. Makos, West Bend, WI (US); Neil Kwiatkowski, Queens, NY (US); Kaitlyn Benoit, New York, NY (US); Meegan Daigler, Brooklyn, NY (US); Charles Paradise, Brooklyn, NY (US)

(21) Appl. No.: 16/400,823

(22) Filed: May 1, 2019

Related U.S. Application Data
(60) Provisional application No. 62/665,939, filed on May 2, 2018.

(51) Int. Cl. A01K 97/12; A01K 77/00; A01K 75/02; G01G 19/60; B25G 1/04

(52) U.S. Cl. CPC A01K 97/125; A01K 77/00; G01S 19/42; G01G 19/60; B25G 1/04; A01K 75/02

(57) ABSTRACT

A hand net device that includes a yoke device having a yoke body, a basket attached to the yoke body, the basket including a net that holds an object and a hoop that attaches to the net, and a handle attached to the yoke body. The hand net device can include a load sensor that generates a weight signal that is proportional to a weight of an object in the basket.

### CROSS REFERENCE TO PRIOR APPLICATION

This application claims priority to and the benefit thereof from U.S. Provisional Patent Application No. 62/665,939, filed May 2, 2018, titled “Hand Net Yoke,” the entirety of which is hereby incorporated herein by reference.

### FIELD OF THE DISCLOSURE

The disclosure relates generally to a hand net device, and, more particularly to a yoke device and a hand net device having a yoke device.

### BACKGROUND OF THE DISCLOSURE

A variety of hand nets are known, including scoop and dip nets. These typically include a net attached to a hoop, which in turn is attached to a pole or handle. The devices come in many shapes and sizes. Hand nets have many applications, including, for example, sweeping up fish near the water's surface or lifting fish out of the water that were caught using a rod and reel.

Known hand nets suffer from a number of disadvantages, including, for example, poor ergonomics that make it difficult or uncomfortable for users to handle. During poor visibility applications, such as, for example, at night time, it is frequently necessary to use a flashlight or some other light source to see the catch in the hand net. Should the user want to know the weight of the catch, then the user will need to take the fish out of the hand net and place it on a weighing scale, which can be especially challenging where the fish continues to flutter or flap.

An unfulfilled need exists for a yoke device and a hand net device with a yoke device that overcome the above-noted disadvantages.

### SUMMARY OF THE DISCLOSURE

According to the principles of the disclosure, a hand net device is disclosed that comprises: a yoke device having a yoke body; a basket attached to the yoke body, the basket including a net that holds an object and a hoop that attaches to the net; and a handle attached to the yoke body. The hand net device can comprise a sensor that generates a sensor signal. The sensor can include a load sensor and the sensor signal can include a weight signal that is proportional to a weight of an object in the basket. The sensor can be located in or on the yoke device, the basket or the hoop. The sensor can comprise at least one of: a water temperature sensor; an ambient temperature sensor; or an atmospheric pressure sensor. The hand net device can comprise a geolocation positioning signal receiver. The hand net device can comprise an actuator. The hand net device can comprise a light emitting element (LEE). The light emitting element can comprise a light emitting diode (LED). The hand net device can comprise an illuminator that can generate and direct a light beam toward the basket. The hand net device can comprise an image pickup device that can capture an image of an object in the basket. The hoop can comprise a reflective finish. The yoke device can comprise a snap button assembly. The yoke device can be hermetically sealed. The yoke body can be adapted to receive and securely hold a module. The yoke module can be provided as a single structure that can be held in the yoke body, or as multiple structures, at least one of which can be held in the yoke body. The yoke body can comprise a module receptacle recess that matches at least one of a size or a shape of the module. The module can include a blank module, an illumination module, a smart module, or a smart module with illumination. The hand net device can comprise a smart device. The smart device can comprise a controller. The hand net device can comprise a hand grip, wherein the hand grip can be movable between a collapsed configuration and a deployed configuration. The snap button assembly can comprise: a lock actuator; and a handle lock. The snap button assembly can comprise a spring mechanism that keeps the handle lock in a lock position until sufficient force is applied to the spring mechanism to allow the handle lock to move from the lock position.

Further, according to the principles of the disclosure, a yoke device is disclosed that comprises: a yoke body; and a module. The module can comprise: a blank module; an illumination module; a smart module; or a smart module with illumination. The yoke body can comprise: an upper body portion; and a lower body portion, wherein the upper body portion snap fits with the lower body portion. The yoke body can comprise a grip, wherein the grip can be movable between a collapsed configuration and a deployed configuration. The yoke body can comprise a module receptacle recess that receives and retains the module. The yoke body can comprise a grip receptacle that receives and holds a portion of the grip. The yoke body can comprise a hoop receptacle that receives and holds a portion of the hoop. The yoke body can comprise a handle receptacle that receives a portion of the handle. The yoke body can comprise a pass-through opening that allows a portion of the handle to pass therethrough and out from the yoke body. The yoke body can comprise a channel that receives and holds a portion of the handle. The channel can comprise a handle lock that engages and locks the handle in a fixed position with respect to the yoke body. The yoke body can comprise a snap button assembly that engages or disengages the handle to control movement of the handle with respect to the yoke body. The snap button assembly can comprise a lock actuator. The snap button assembly can comprise a handle lock that engages and locks the handle in a fixed position with respect to the yoke body. The snap button assembly can comprise: a spring mechanism; and a fastener that attaches the lock actuator to the yoke body, wherein the lock actuator pivots about a longitudinal axis of the fastener.

Still further, according to the principles of the disclosure, a module is disclosed that comprises: a processor that receives a sensor signal and generates a catch event signal based on the received sensor signal; and a network interface that receives the catch event signal from the processor and transmits the catch event signal to a personal user device. The sensor signal can comprise a video signal, an image signal, a weight signal, a time signal, a geolocation signal, an ambient sensor signal, or a sensor status signal. The processor can receive the sensor signal from a sensor located in at least one of a hoop, a yoke body, and a handle. The sensor can comprise an image pickup device, a load sensor, a weight sensor, a temperature sensor, or a pressure sensor. The module can comprise a strain sensor interface that receives a signal from a sensor located in at least one of a hoop, a yoke body, and a handle, and outputs the sensor signal to the processor. The sensor can comprise a load sensor and the sensor signal can comprise a weight signal, wherein the load sensor can generate the weight signal based on a force applied to at least one of the hoop, the handle, or the yoke body. The processor can receive an ambient sensor signal that includes ambient sensor data in the catch event signal. The module can include an ambient sensor interface that receives a signal from an ambient sensor and outputs the ambient sensor signal to the processor. The ambient sensor can comprise at least one of: an ambient condition sensor; and a water condition sensor. The ambient condition can comprise at least one of: air temperature; humidity; and atmospheric pressure. The water condition can comprise water temperature. The module can comprise a geolocation positioning device (such as, for example, a GPS receiver) that determines the geographic coordinates of the module. The module can comprise a light emitting element (LEE), wherein the light emitting element (LEE) can comprise a light emitting diode (LED). The module can comprise an illumination driver that controls an illuminator to emit a light beam.

Still further, according to the principles of the disclosure, a smart net process and system for capturing and storing fishing catch events are disclosed, which comprise: a smart module that communicates with a personal user device or a network, wherein the smart module determines a catch event and transmits a catch event signal to the personal user device or network. The smart net method comprises: creating an event record; receiving a catch event signal from the smart module; and updating the event record based on the catch event signal. The smart net method can comprise: receiving location data from a personal user device or a smart module; and updating the event record to include the location data. The smart net method can comprise displaying a catch event screen on the personal user device based on the catch event signal. The smart net method can comprise generating a chart or a graph. The chart or graph can be generated based on the event record. The smart net method can comprise rendering an image on a display device. The catch event signal can comprise a fish weight signal. The smart net method can comprise receiving ambient condition data and updating the event record based on the ambient condition data. The ambient condition can comprise at least one of: a moon phase; ambient temperature; ambient humidity; and ambient pressure. The smart net method can comprise receiving water condition data and updating the event record based on the water condition data. The water condition can comprise water temperature. The smart net method can comprise: receiving a photo; and updating the event record to include the photo. The smart net method can comprise: receiving a search term from the personal user device; retrieving a catch event record based on the search term; and displaying the catch event record based on the search term. The search term can comprise at least one of: a geographic location; a fish species; a date; a time; and a fish weight.

Additional features, advantages, and embodiments of the disclosure may be set forth or apparent from consideration of the following detailed description, drawings, and claims. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced.

FIG. 1 shows an embodiment of a hand net device constructed according to the principles of the disclosure.

FIG. 2 shows a perspective view of an embodiment of a yoke device constructed according to the principles of the disclosure.

FIG. 3 shows a side view of another embodiment of a yoke device constructed according to the principles of the disclosure.

FIG. 4 shows a top view of the yoke device in FIG. 3.

FIG. 5 shows a bottom view of the yoke device in FIG. 3.

FIG. 6 shows a front view of the yoke device in FIG. 3 with a grip in a deployed position.

FIG. 7 shows a front view of the yoke device in FIG. 3 with the grip in a collapsed position.

FIG. 8 shows an exploded view of the yoke device in FIG. 3, including an embodiment of a yoke module.

FIG. 9 shows an exploded view of a lower body portion and a grip of the yoke device in FIG. 3.

FIG. 10 shows another exploded view of the lower body portion and grip of the yoke device in FIG. 3.

FIG. 11 shows an exploded view of the yoke device in FIG. 3, including the yoke module.

FIG. 12 shows a length-wise cross-cut view of the yoke device in FIG. 3.

FIG. 13 shows a side view of the yoke module in FIGS. 3-8 and 11.

FIG. 14 shows a top view of the yoke module in FIGS. 3-8, 11, and 13;

FIG. 15 shows an embodiment of a controller that can be included in the yoke module in FIGS. 3-8, 11, and 13.

FIG. 16 shows an embodiment of a yoke device with an illuminator, constructed according to the principles of the disclosure.

FIG. 17 shows a smart hand net system, constructed according to the principles of the disclosure.

FIG. 18 shows an example of a smart net process, according to the principles of the disclosure.

FIGS. 19 and 20 show various views of a personal user device carrying out the smart net process in FIG. 18, according to the principles of the disclosure.

The present disclosure is further described in the detailed description and drawings that follows.

### DETAILED DESCRIPTION OF THE DISCLOSURE

The embodiments of the disclosure and the various features and advantageous details thereof are explained more fully with reference to the non-limiting embodiments and examples that are described or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure, which is defined solely by the appended claims and applicable law. Moreover, it is noted that like reference numerals represent similar parts throughout the several views of the drawings.

Hand Net Device

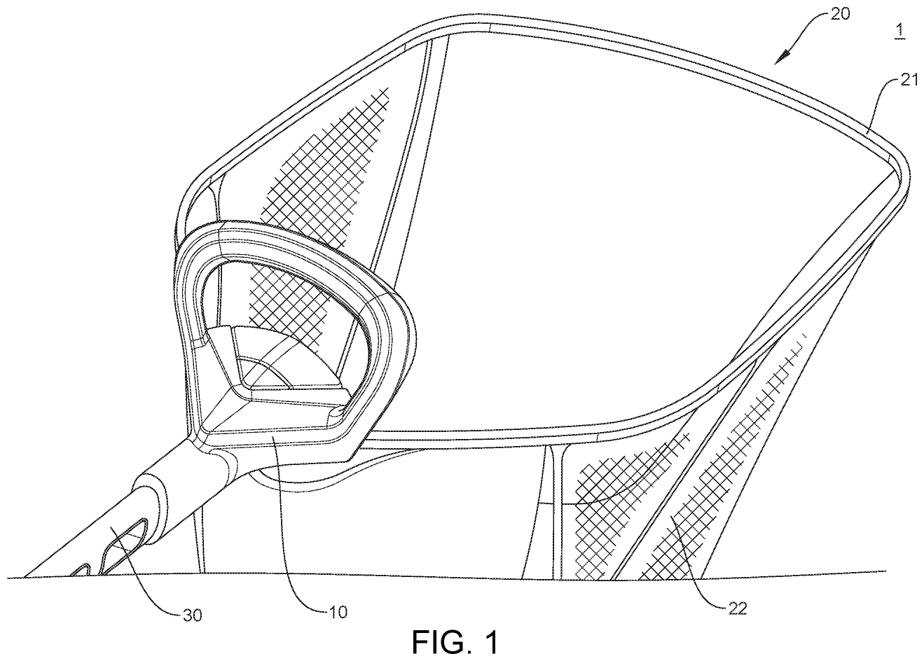

FIG. 1 shows an embodiment of a hand net device 1 constructed according to the principles of the disclosure. The hand net device 1 comprises a yoke device 10, a basket 20, and a handle 30. The basket 20 can comprise a hoop 21 and a net 22. The handle 30 can comprise a handle or a pole that can be gripped by a user during implementation of the hand net device 1.

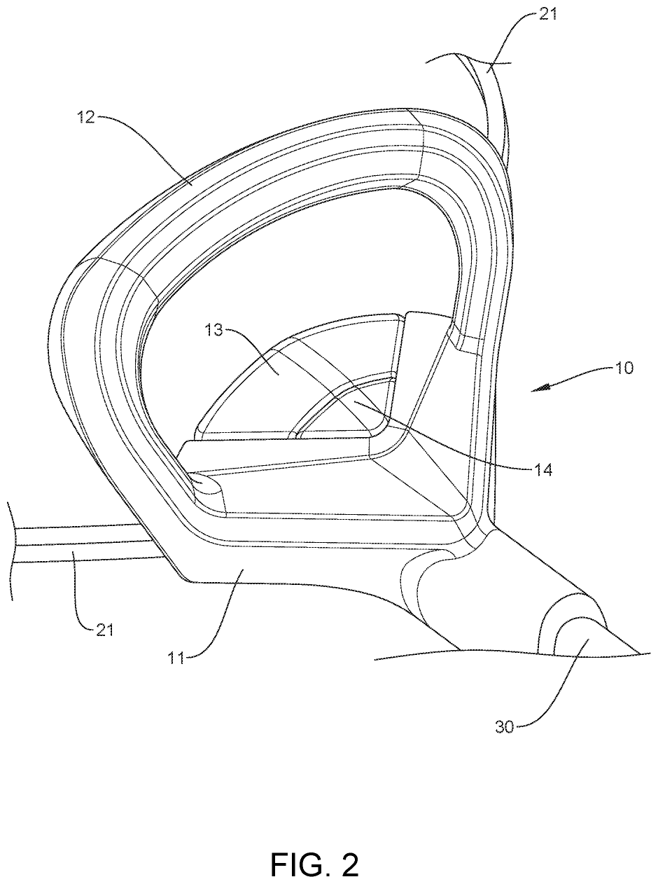

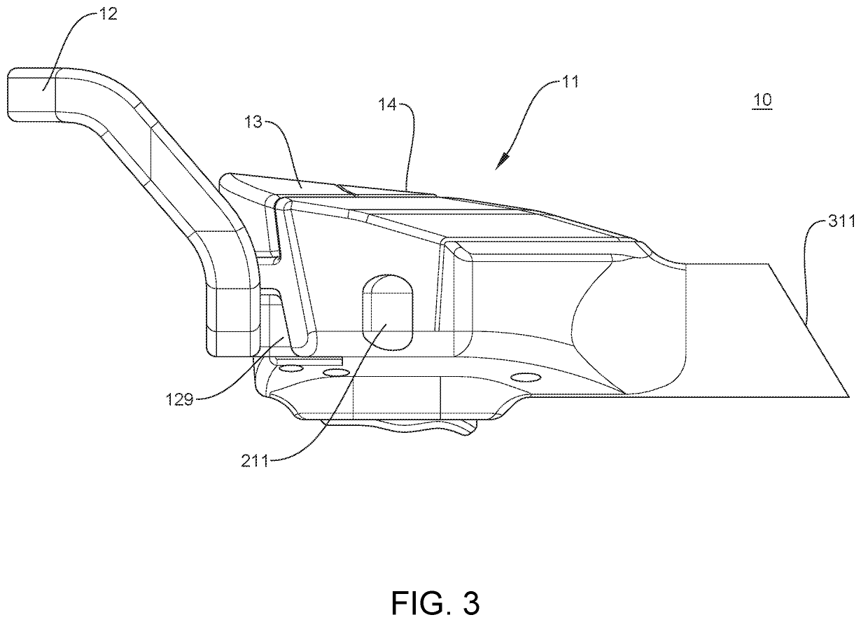

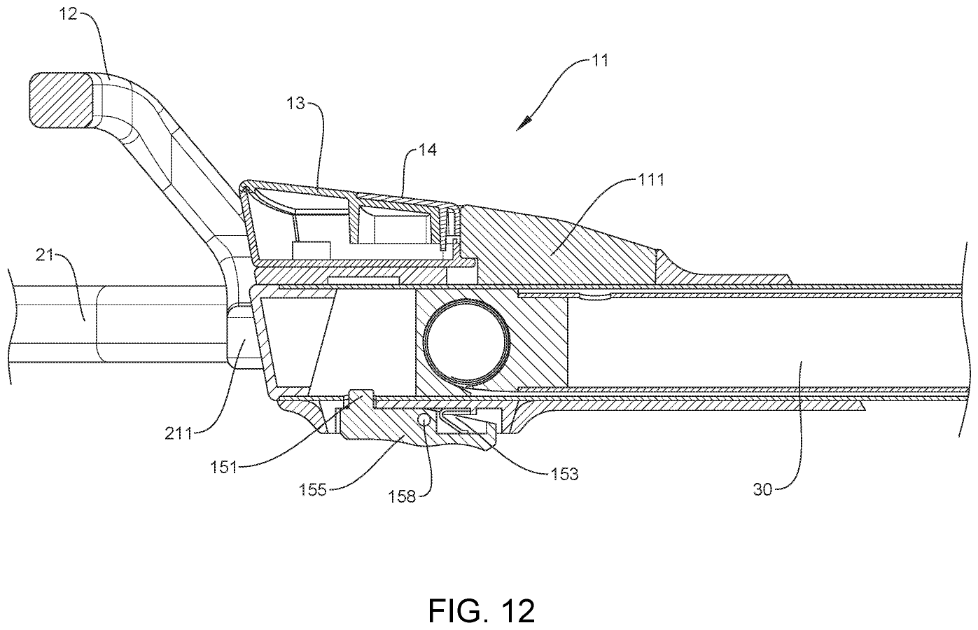

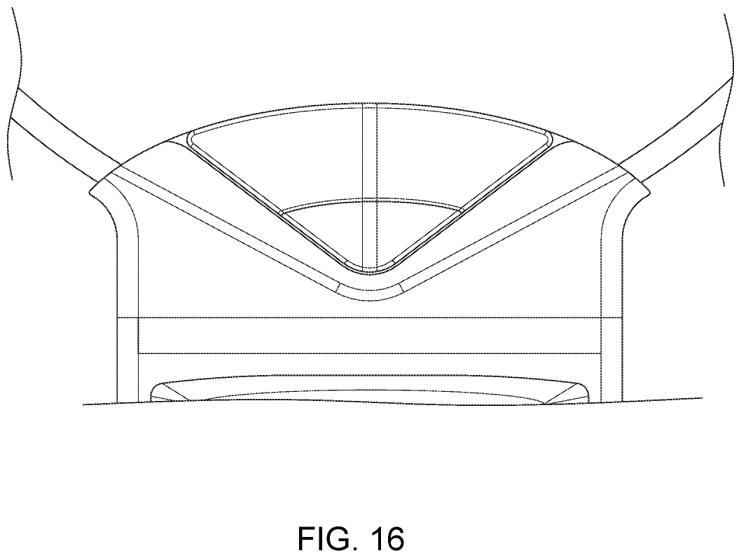

FIG. 2 shows a perspective view of an embodiment of the yoke device 10 constructed according to the principles of the disclosure. The yoke device 10 can be attached to the hoop 21 and the handle 30. The yoke device 10 includes a yoke body 11. The yoke device 10 can include a grip 12. The grip 12 can be formed integrally with or fixedly attached to the yoke body 11, as seen in FIGS. 1 and 2; or, the grip 12 can be adjustable with respect to the yoke body 11, as seen in FIGS. 3-11. The yoke device 10 can include a yoke module 13. The yoke module can include a blank module (shown in FIG. 12), an illumination module (shown in FIG. 16), a smart module (shown in FIGS. 2-8, 11, 13-14, and 17), or a smart module with illumination (shown in FIGS. 1 and 16). The yoke device 10 can include one or more actuators 14. The actuator(s) 14 can be formed as part of the module 13.

The actuator 14 can include an ON/OFF button, a plurality of buttons, a keypad, a keyboard, a touch-screen display, a microphone with speech recognition or command, a toggle switch, a joy stick, or any other device suitable as a human-machine interface. The actuator 14 can be coupled to the yoke module 13, an illuminator (discussed below) that generates and directs a light beam toward the basket 20, which can be positioned to illuminate the inside of the basket 20, or an image pickup device (not shown) such as, for example, a camera that can be positioned to capture an image of the inside of the basket 20 or an external to the basket 20. The actuator 14 can turn ON/OFF the yoke module 13, illuminator or image pickup device, or control various functionalities of the yoke module 13, illuminator, or image pickup device, as discussed below.

Yoke Device

FIG. 3 shows a side view of another embodiment of the yoke device 10. The yoke device 10 has a yoke body 11 that can include a hoop receptacle 211 and a handle receptacle 311. The hoop receptacle 211 can be formed to receive and securely attach a portion of the hoop 21 to the yoke body 11. Alternatively, the hoop 21 can be attached to the yoke body 11 by means (not shown) other than the hoop receptacle 211. For instance, a portion of the hoop 21 can be attached to an external portion of the yoke body 11 by such means as a fastener, or the hoop 21 can be formed integrally with and as part of the yoke body 11 (shown in FIGS. 1 and 2).

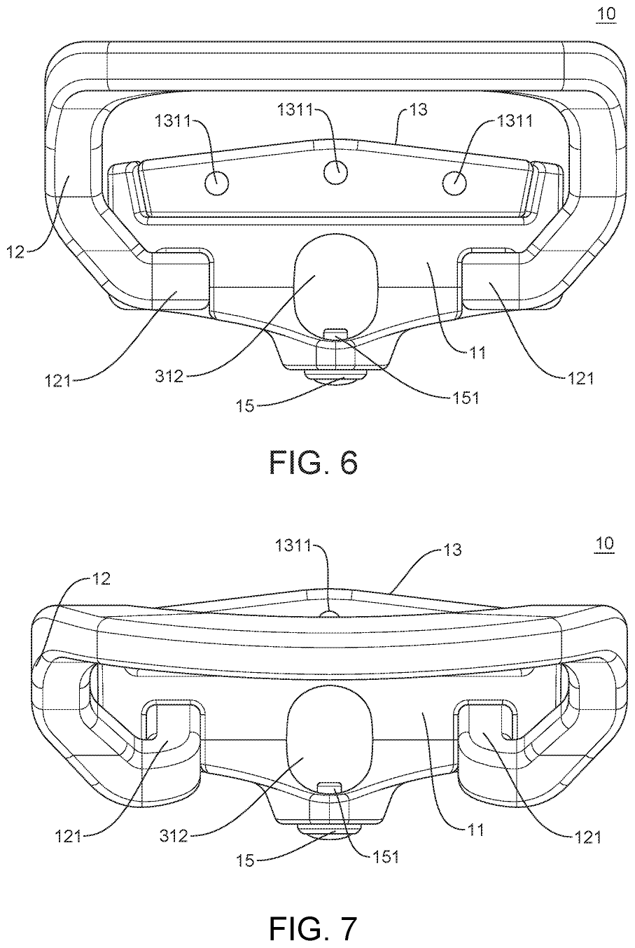

The yoke device 10 can include a grip receptacle 129 that is formed to receive and securely attach a portion 121 of the grip 12. The grip receptacle 129 can be formed to allow the portion 121 of the grip 12 to move between a deployed (shown in FIG. 6) and collapsed (shown in FIG. 7) configuration. Alternatively, the grip 12 can be attached to the yoke body 11 by means (not shown) other than the grip receptacle 129. For instance, a portion of the grip 12 can be attached to an external portion of the yoke body 11 by means of a fastener, or the grip 12 can be formed integrally with and as part of the yoke body 11 (shown in FIGS. 1 and 2).

The handle receptacle 311 can be formed to receive and securely hold a portion of the handle 30 in (or through) the yoke body 11. Alternatively, the handle 30 can be attached to the yoke body 11 by means (not shown) other than the handle receptacle 311. For instance, a portion of the handle 30 can be attached to an external portion of the yoke body 11 by means of a fastener, or the handle 30 can be formed integrally with and as part of the yoke body 11.

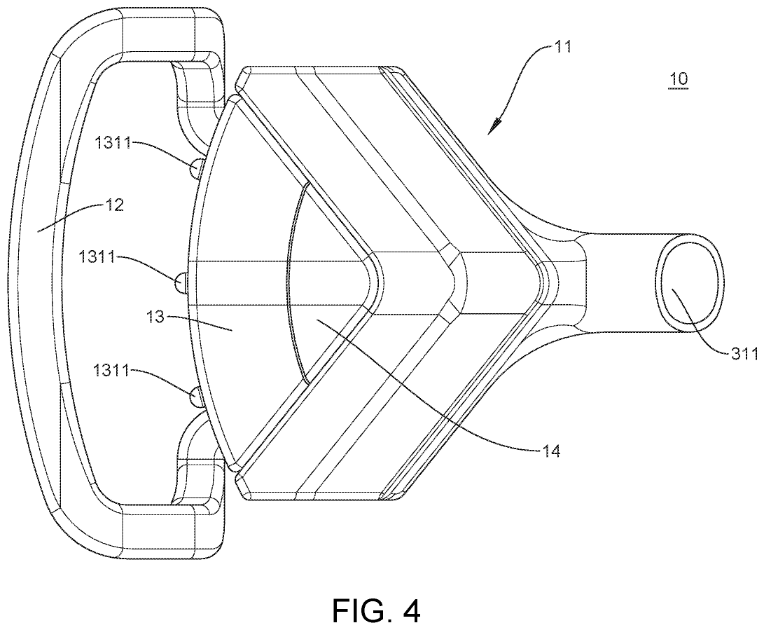

FIG. 4 shows a top view of the yoke device 10. As seen in this illustration, the yoke module 13 can include a display 1311. The display 1311 can be located anywhere on the yoke device 10 where it could be easily viewed by the user. The display 1311 can include, for example, one or more light emitting elements (LEEs). The display 1311 can include one or more arrays of LEEs, such as, for example, a one-dimensional (1-D) array of LEEs (as shown in FIG. 4) or a multi-dimensional array of LEEs (not shown), such as, for example, a two-dimensional (2-D) array or a three-dimensional (3-D) array. The LEE(s) 1311 can include, for example, light emitting diodes (LEDs), organic light emitting diodes (OLEDs), quantum dot light emitting diodes (QLEDs), quantum dot (QD) display elements, liquid crystal display (LCD) elements, holographic projection elements, or the like.

In the case where the display 1311 includes a 1-D array of LEDs, OLEDs, QLEDs, or the like, the display 1311 can be positioned on the front of the yoke module 13, as seen in FIG. 4. In the case where the display 1311 includes a multi-dimensional array of LEEs (not shown), the display 1311 can be positioned on the top of the yoke module 13.

The yoke device 10 can include an image pickup device (not shown). The image pickup device (not shown) can be positioned to capture an image of an area inside the basket 20, or an area outside of the basket 20. The yoke device 10, including the display 1311 and image pickup device, can be formed to be water resistant, thereby allowing the yoke device 10 to be submersed into water without risk of water entering any of the electrical components in the yoke device 10. The yoke device 10, including the display 1311 or image pickup device (not shown), can be hermetically sealed.

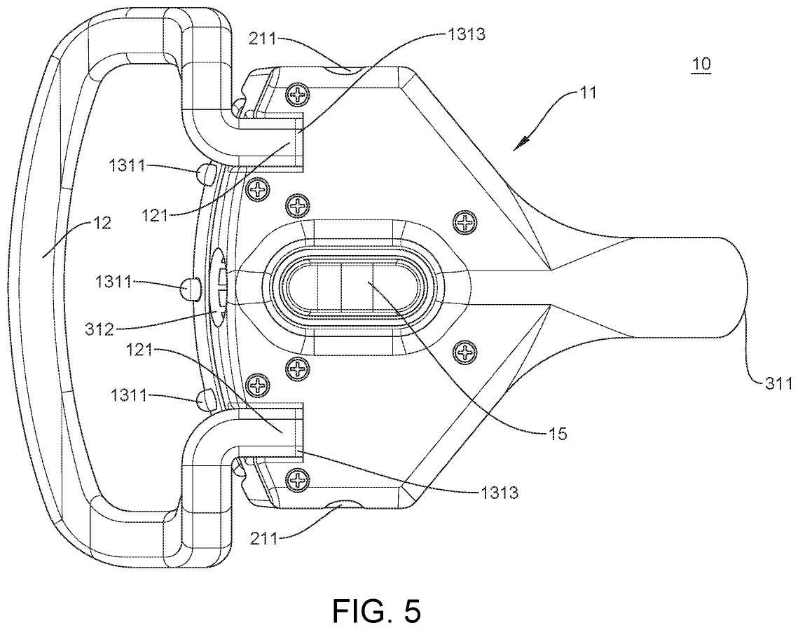

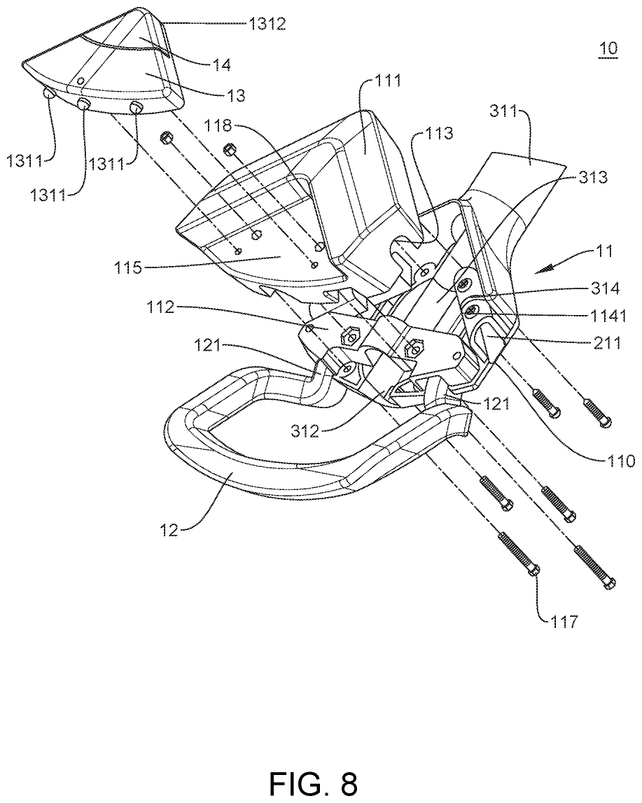

FIG. 5 shows a bottom view of the yoke device 10. The yoke device 10 can include a snap button assembly 15, which can include a handle lock 151 (shown in FIGS. 6 and 7). The yoke body 11 can include a grip receiver 1313 that is configured to receive and hold the portion 121 of the grip 12. The yoke body 11 can include a pass-through opening 312 that allows the handle 30, after being inserted through the handle receptacle 311, to pass through the opening 312 toward an end portion of the basket 20. The yoke body 11 can include a pass-through, as seen in FIGS. 8 and 12. This design permits the handle 30 to be inserted in and through the yoke body 11 toward the end portion of the basket 20, thereby providing a compact design that requires less storage space and easier transport. This design can also permit the user to slide an end of the handle 30 up to the end of the basket 20, thereby securing large objects (such as, e.g., fish) in the basket 20 and, possibly, reducing a likelihood that the objects fall or jump out of the basket 20 while walking or otherwise carrying the net device 1.

FIGS. 6 and 7 show a front view of the yoke device 10 with the grip 12 in a deployed position and a collapsed position, respectively. The grip 12 is designed to be collapsed as seen in FIG. 7, so as to provide a compact configuration for the yoke device 10. During use, the grip 12 can be kept collapsed (as seen in FIG. 7) or deployed (as seen in FIG. 6). When lifting the basket 20 out the of the water, the grip 12 can be moved to the fully deployed position, so that it can be easily gripped by the user when, for example, scooping up a fish.

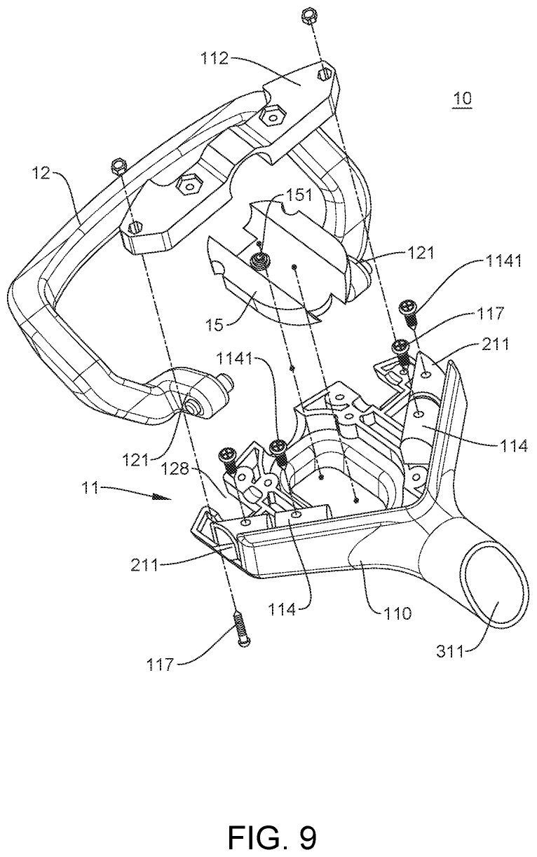

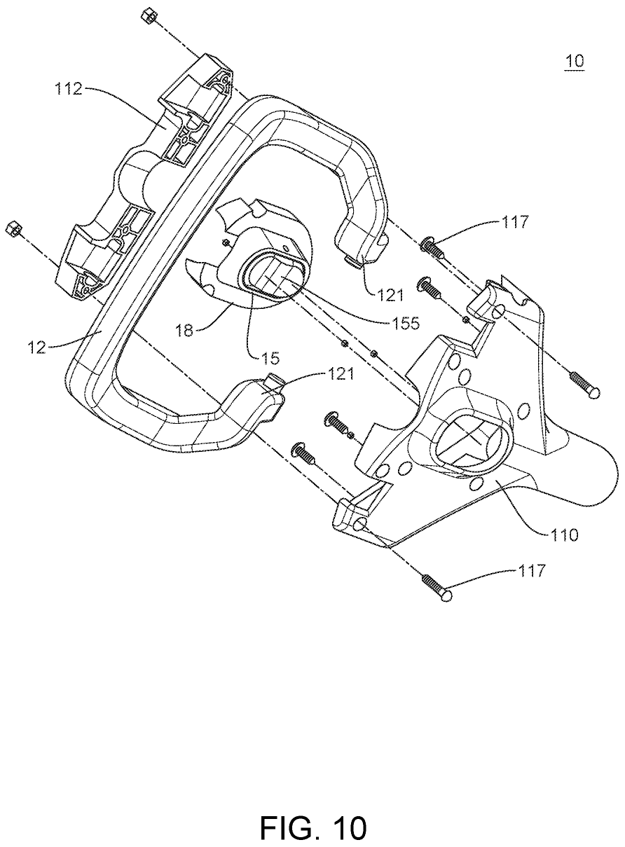

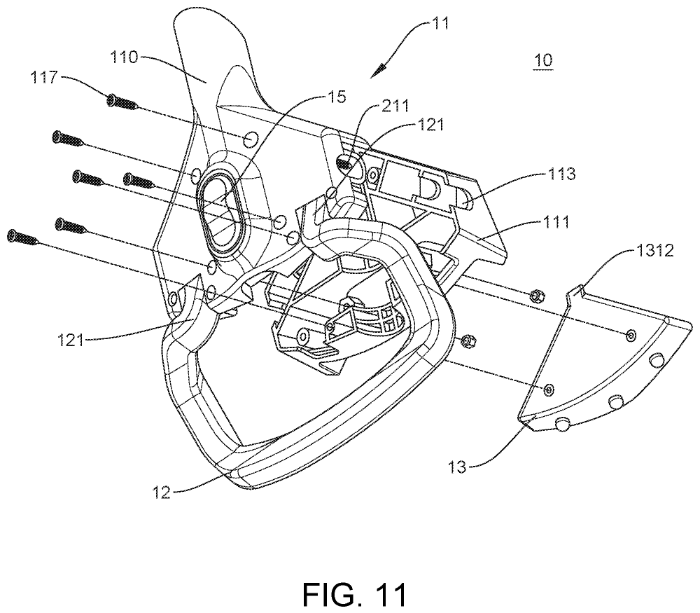

FIGS. 8-11 show various exploded views of the yoke device 10. More specifically: FIG. 8 shows an exploded view of the yoke device 10 with the yoke module 13; FIGS. 9 and 10 show exploded views of a lower body portion 110 and the grip 12 in the yoke device 10; and FIG. 11 shows an exploded view of the yoke device 10 with the yoke module 13. As seen in the figures, the yoke body 11 can be formed from a plurality of components, which can be assembled into a single unitary structure (such as, e.g., shown in FIGS. 1-7). Alternatively, the yoke body 11 can be formed as a single structure, without any need for assembly of components.

Referring to FIGS. 8-11, the yoke body 11 can include an upper body portion 111 and a lower body portion 110. The upper body portion 111 can include a module receptacle recess 115 that is configured to receive and mate with the yoke module 13 for a snug and secure fit. The recess 115 can have a shape and/or a size that matches the shape and/or size of the yoke module 13. The yoke module 13 can be installed in the recess 115 and fastened to the upper body portion 111 by means of a fastener. For instance, the upper body portion 111 can include a groove 118 that receives and mates with a tongue 1312 on the yoke module 13. Additionally, a fastener 117 can be used to secure the yoke module 13 to the upper body portion 111. In this instance, the yoke module 13 can be readily installed into the upper body portion 111 by aligning the yoke module 13 with the recess 115 and inserting the portion of the yoke module 13 that includes the tongue 1312 into the portion of the recess 115 where the groove 118 is located until the yoke module 13 snaps into place and fully resides in the recess 115. The yoke module 13 can then be fastened to the upper body portion 111 by means of one or more fasteners 117. Alternatively, the yoke module 13 can be attached to the yoke body 11 without a recess 115, as understood by those skilled in the art.

The yoke device 10 can be configured to be a smart device. The yoke device 10 can include a yoke module 13 that comprises the smart module or smart module with illumination (as noted above) or image pickup (as noted above). Alternatively, the yoke device 10 can include a blank module or an illumination module with or without image pickup, as noted above. The housing for the yoke module 13 can be formed as part of the yoke body 11 as a single piece, or formed as a component that can be installed in the recess 115 of the upper body portion 111, as discussed above. Accordingly, the yoke device 10 can be configured with or without the yoke module 13; and, in the latter instance, it can be configured with any one of a blank module, an illumination module, a smart module, or a smart module with illumination, as discussed above, depending on the user's needs.

The upper body portion 111 can include one or more cutouts for the grip portion 121 and the pass-through opening 312. The cutouts in the upper body portion 111 together with the cutouts 128 (shown in FIG. 9) form the grip receptacle 129. As noted above, the grip receptacle 129 can be designed to allow the grip portion 121 to move, for example, up/down when the grip 12 is moved between the deployed and collapsed positions. The upper body portion 111 can include a cutout 113 for the hoop receptacle 211 in the yoke body 11.

The lower body portion 110 can include a channel 313 that runs lengthwise in the lower body portion 110, running between the openings 311 and 312. The channel 313 can be configured to allow a portion of the handle 30 (shown in FIG. 12) to enter via the handle receptacle 311 and slide along the entire length of the channel 313 and out through the pass-through opening 312, or a portion of the length of the channel 313, in which case the handle 30 would not pass through the opening 312.

As seen in FIG. 9, the lower body portion 110 can include the snap button assembly 15, which can be secured to the lower body portion 110 by means of a bridge portion 112, which in turn can be attached to the lower body portion 110 by means of a fastener 117. The lower body portion 110 can include a pair of chambers 114 to house the portions of the hoop 21 that are inserted into the hoop receptacles 211. The upper body portion 111 and lower body portion 110 can be formed to snap together (e.g., by means of tongue-and-groove) to form the yoke body 11.

As seen in FIGS. 8 and 9, one or both of the chambers 114 can include a load sensor 1141 that accurately senses a strain placed on the hoop 21 and/or the yoke device 10 and generates a signal proportional to the strain placed on the hoop 21 and/or yoke device 10. The load sensor 1141 can be positioned against the portion of the hoop 21 that is located in the chamber 114. In FIGS. 8 and 9, the load sensor 1141 is illustrated as having a shape of a screw that can be threaded into the chamber 14 and pressed against the portion of the hoop 21 located in the chamber 14. The load sensor can transmit the generated signal as a weight signal that is indicative of weight (or force) applied to the hoop 21 and/or yoke 10.

Alternatively (or additionally), a load sensor 1141 can be installed in the bridge 112, or the snap button assembly 15, or in some other location in the yoke body 11 where the load sensor can sense and measure a strain force applied and/or transferred to the yoke body 11 or handle 30, such as, for example, when a fish is placed in the basket 20.

FIG. 12 shows a lengthwise cross-cut view of the yoke device 10. Referring to FIGS. 9, 10, and 12, the snap button assembly 15 can have a housing 18 that holds a lock actuator 155 and the handle lock 151. As seen in FIG. 12, the lock actuator 155 and handle lock 151 can be formed as a single member that can pivot about a lock fastener 158 between an engagement position (shown in FIG. 12) and a disengagement position (not shown), whereby the handle lock 151 is retracted completely from the channel 313. The snap button assembly 15 can include a spring mechanism 153 (such as, e.g., a spring, memory steel, memory plastic, or the like) that forces the lock actuator 155 and handle lock 151 into the engagement position until sufficient force is applied to a portion of the lock actuator 155 to force the lock actuator 155 to compress the spring mechanism 153 and to pivot about the fastener 158 to retract the handle lock 151 from the channel 313.

Accordingly, a user can slide and adjust the position of the handle 30 with respect to the yoke body 11 by applying a force to the lock actuator 155 using one hand, while simultaneously pulling/pushing the handle 30 from/into the yoke body 11.

Smart Module

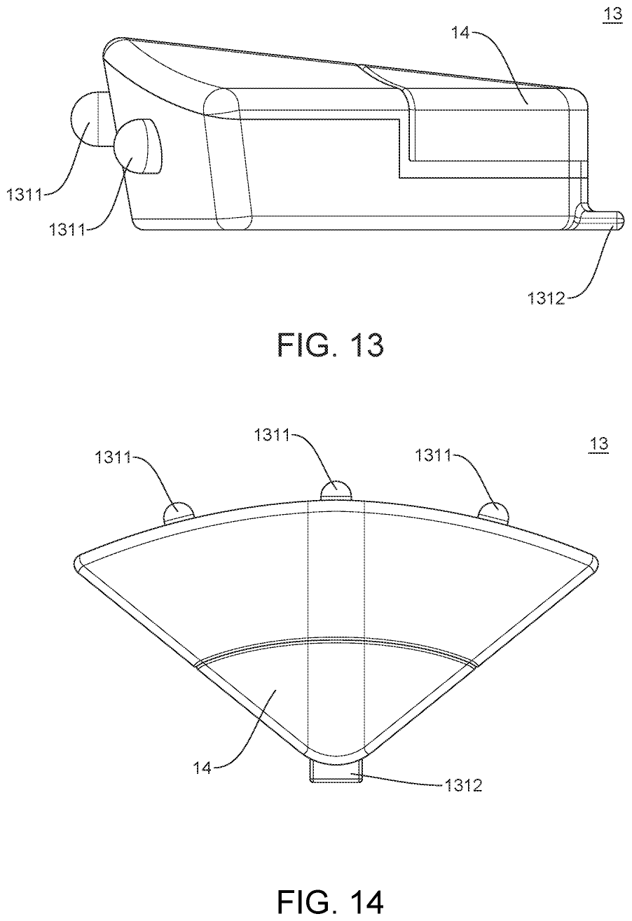

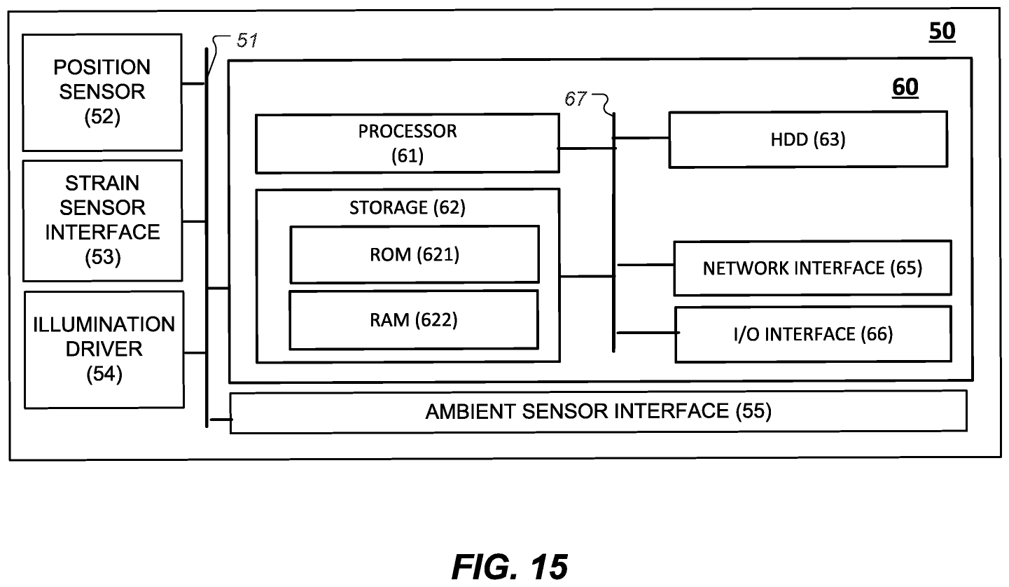

FIGS. 13 and 14 show side and top views, respectively, of an embodiment of the yoke module 13 that comprises a smart module with illumination; and, FIG. 15 shows an embodiment of a controller 50 that can be included in the smart module with illumination.

Referring to FIG. 15, the controller 50 is constructed according to the principles of the disclosure and is configured to implement the various aspects of the disclosure. The controller 50 includes a microcontroller 60, a geolocation position sensor 52, a strain sensor interface 53, an illumination driver 54, and an ambient sensor interface 55, all of which can be communicatively coupled to a system bus 51. The system bus 51 can be any of several types of bus structures that can further interconnect to a memory bus (with or without a memory controller), a peripheral bus, and a local bus using any of a variety of commercially available bus architectures.

The microcontroller 60 includes a processor 61. The processor 61 can be any of various commercially available microprocessors. Dual microprocessors and other multi-processor architectures can also be employed as the processor 61.

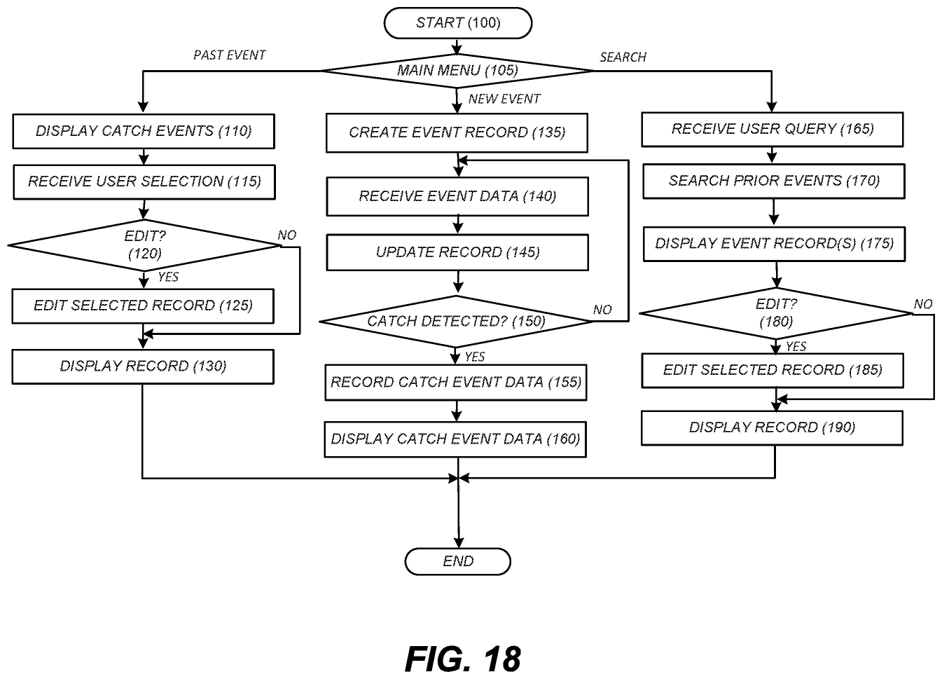

The microcontroller 60 includes a computer-readable medium that can hold executable or interpretable computer code (or instructions) that, when executed by the processor 61, causes the steps, processes and methods described herein to be carried out. The computer-readable medium can be provided in a memory storage 62 or a hard drive (HD) 63. The computer readable medium can include sections of computer code that, when executed by the processor 61, cause the controller 50 to carry out each of the steps shown in FIG. 18, as well as all other process steps described and contemplated herein.

The storage 62 includes a read only memory (ROM) 621 and a random-access memory (RAM) 622. A basic input/output system (BIOS) or software can be stored in the non-volatile memory 621, which can include, for example, a ROM, an EPROM, an EEPROM, or other non-volatile storage medium. The software can contain the basic routines that help to transfer information between elements within the microcontroller 60 and, more generally, the controller 50 such as during start-up. The RAM 622 can include a high-speed RAM such as static RAM for caching data.

The microcontroller 60 can include an internal storage or hard drive (HD) 63. The HD 63 can be connected to a bus 67 by a memory interface (not shown) or a hard disk drive interface (not shown). The HD 63 and its associated computer-readable media, can provide nonvolatile storage of data, data structures, computer-executable instructions, and the like. The HD 63 can accommodate the storage of any data in a suitable digital format. The storage 62 and/or HD 63 can include one or more apps that are used to execute aspects of the architecture described herein, including an app that includes sections of code to carry out the process shown in FIG. 18 and described herein.

A number of program modules can be stored in the HD 63 or storage 62, including an operating system (not shown), one or more application programs (not shown), other program modules (not shown), and program data (not shown). Any (or all) of the operating system, application programs, program modules, and program data can be cached in the storage 62 as executable sections of computer code.

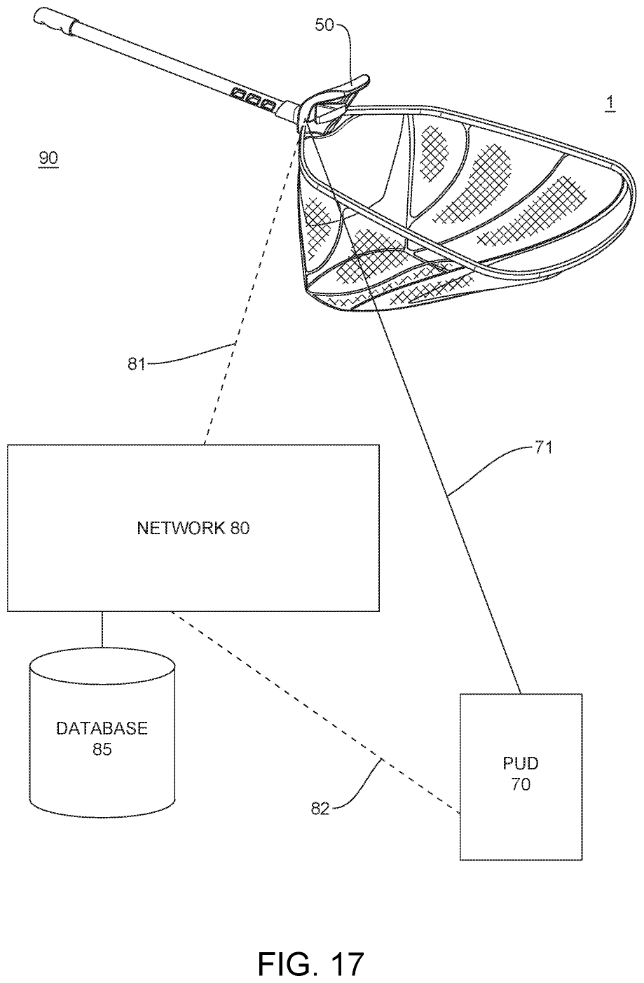

The microcontroller 60 can include a network interface 65. The network interface 65 can be connected to a personal user device 70 or a network 80 via one or more communication links 71, 81, 82 (shown in FIG. 17). The network interface 65 can include a wired or a wireless communication network interface (not shown) and/or a modem (not shown). When used in a local area network (LAN), the controller 50 can be connected to the LAN network through the wired and/or wireless communication network interface; and, when used in a wide area network (WAN), the controller 50 can be connected to the WAN network through the modem. The network (not shown) can include a LAN, a WAN, or the like. The modem (not shown) can be internal or external and wired or wireless. The modem can be connected to the system bus 51 via, for example, a serial port interface (not shown) or passed through.

The microcontroller 60 can include an input/output (I/O) interface 66. The microcontroller 60 can receive commands and data from an operator via the I/O interface 66, which can be communicatively coupled the actuator 14 (described above) and/or to one or more input/output devices, including, for example, a keyboard (not shown), a keypad (not shown), a touch-screen-display (not shown), a microphone (not shown), a speaker (not shown), a display (not shown), or an image pickup sensor (not shown). The received command and data can be forward to the processor 61 from the I/O interface 66 as instruction and data signals via the bus 67.

The position sensor 52 can be connected to the system bus 51 by means of a communication link. The position sensor 52 can be configured to receive signals and to determine precise location in three Cartesian position coordinates (x, y, z), as well as latitude and longitude coordinates (in degrees, minutes, and seconds). The position sensor 52 can transmit location signals in real-time to the microcontroller 60 via system bus 51.

The strain sensor interface 53 can be connected to one or more load sensors 1141 by means of a communication link. The strain sensor interface 53 can be configured to receive load signals from the one or more load sensors 1141 over the communication link and transmit load information to the microcontroller 60 in the form of a weight signal via the system bus 51.

The one or more load sensors 1141 can be fixed in or to the hoop 21 and/or in or to the yoke device 10 (as discussed above, with reference to FIGS. 8 and 9). Alternatively, the load sensor(s) 1141 can be fixed in or to the handle 30. The load sensor(s) 1141 can be positioned such that it accurately senses and measures a strain placed on or transferred to the hoop 21 or the yoke device 10 (or handle 30) by an object (such as, for example, a fish) in the basket 20 and generates a weight signal representative of the actual weight of the object. The load sensor(s) 1141 generates a signal that is proportional to strain forces exerted on the basket 20 by the weight of the object in the basket 20. The weight signal can be transmitted to the strain sensor interface 53 over the communication link established between the strain sensor interface 53 and load sensor(s) 1141. The weight signal can then be forwarded from the strain sensor interface 53 to the microcontroller 60.

The load sensor 1141 can include, but is not limited to, for example, a force sensitive resistor, a load cell, a piezoresistive sensor, a capacitive sensor, a micro-electronic-mechanism sensor (MEMS), or any other device suitable for the intended purpose.

The illumination driver 54 can be connected to the system bus 51 and an illuminator (shown in FIG. 16) by means of a communication link. The illumination driver 54 can be configured to communicate with and drive the illuminator to thereby power, turn ON/OFF or adjust the light beam generated by the illuminator, including adjustment of beam intensity, beam angle, beam spread, and the like. The illuminator can include one or more LEDs, OLEDs, QLEDs, or any other device that can emit visible light and direct the light toward and into the basket 20. The illuminator can facilitate night vision. The illuminator can be located in (or on) the yoke device 10 or in (or on) the hoop 21.

The hoop 21 can include a reflective finish to make it easily visible to the user, especially when a light beam is directed on the hoop 21 from the illuminator.

Smart Net App

FIG. 17 shows an embodiment of a smart hand net (SHN) system 90, constructed according to the principles of the disclosure. The SHN system 90 comprises the hand net device 1 and a personal user device (PUD) 70. The SHN system 90 can include a network 80. The SHN system 90 can include a database 85. The hand net device 1 can include the module 13, which can communicate with the PUD 70 over a direct communication link 71. Alternatively, the module 13 can communicate with the PUD 70 via the network 80 over communication links 81, 82.

The PUD 70 can connect through, for example, a phone, a smart phone, a display, a tablet, a computer, or a personal data assistant (PDA). The PUD 70 can include a database. The PUD 70 can be connected to the Internet.

FIG. 18 shows an example of a smart net process that can be carried out by the controller 50 (shown in FIG. 15) in the hand net device 1, according the principles of the instant disclosure. The controller 50 can be pre-programmed with a set of instructions or computer code to carry out each of the steps in the smart net process. The instructions can be stored as sections of computer code in a computer readable medium, which can be located in the storage 62 or HD 63 (shown in FIG. 15).

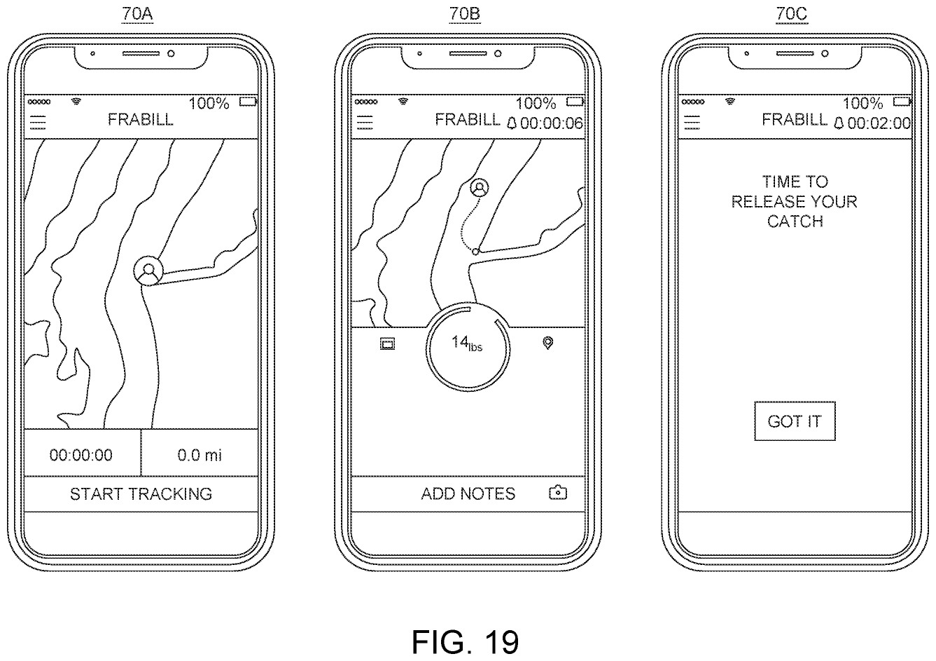

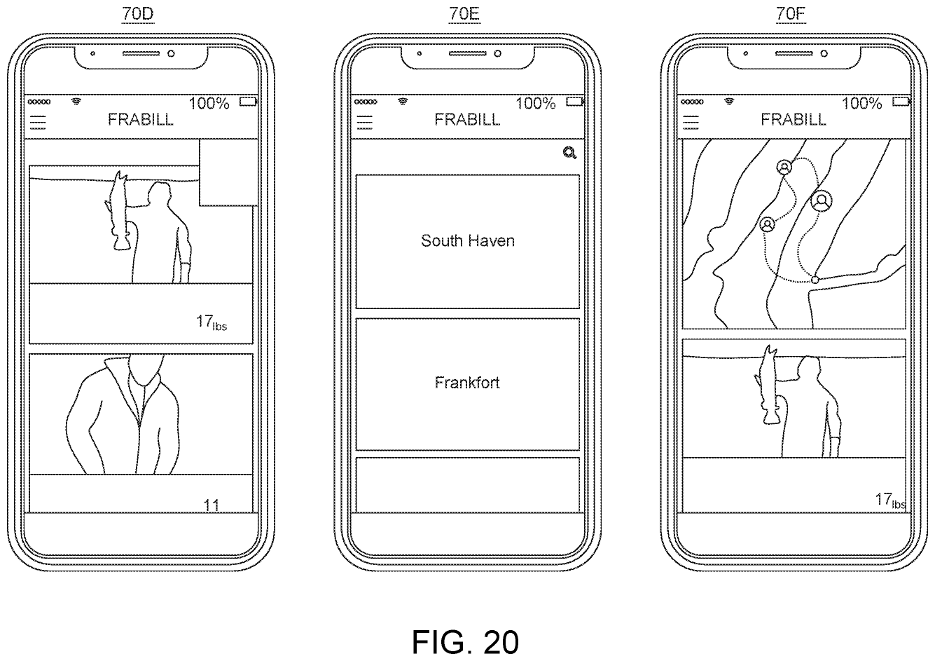

FIGS. 19 and 20 show various views of an example of a PUD 70 carrying out the smart net process in FIG. 18.

Referring to FIGS. 15 and 17-20 concurrently, a user may initiate the smart net process on the PUD 70 by, for example, selecting a thumbnail icon on the PUD 70 (Step 100). The selection of the icon (Step 100) can cause the PUD 70 to call and execute the program on the PUD 70 to carry out the steps of the smart net process. The PUD 70 can begin the process by displaying a main menu (Step 105) or a home screen 70A (shown in FIG. 19), from which the main menu can be selected (Step 105). The home screen 70A can show a geographical map with the actual real-time location of the PUD 70 (or the controller 50). The process works with the GPS receiver (not shown) in the PUD 70 to log the device's (and thereby the user's) location.

From the home screen 70A (or main menu) the user can begin a new event (NEW EVENT at Step 105) by selecting a START TRACKING button on the PUD 70. Selection of the new event can cause the PUD 70 to create a communication session over the communication link 71 (or via the communication links 81, 82 and network 80) with the controller 50 and create a new event record (Step 135). The event record can be stored locally in the PUD 70 or in a database 85 that can be located remotely. The event record can include a plurality of data fields, each for a distinct event. The event data can include, for example, geographic location data, date data, time data, basket 20 weight data, weight data of an object in basket 20, air temperature data, ambient pressure data, ambient humidity data, wind data, water temperature data, water velocity data, water direction of flow data, tide data, or moon-phase data. Many of the foregoing data types, including the geographic location, can be received from the PUD 70 or the network 80. The net device 1 can include additional sensors to measure and record each of the foregoing types of data.

The net device 1 can include one or more sensors (not shown) to monitor or measure biometric data of the user such as, for example, heart rate, skin temperature, steps walked with the net device 1, or time spent standing while holding the net device 1. In this regard, the sensors can be located on the yoke device 10 or the handle 30.

The PUD 70 can periodically open a communication session with the controller 50 to receive event data from the controller 50 in real-time (Step 140). The received event data can be stored in the associated fields in the event record (created at Step 135). The communication session can be kept continuously open until terminated by the PUD 70 or controller 50. Where it is desirable to preserve battery life in the PUD 70 or controller 50, the communication session should not be kept continuously open for any extended period of time.

Many of the foregoing types of event data can be retrieved from government, commercial, university, and private databases based on the geographic location of the PUD 70 or controller 50 for a specific date and time period. In those instances, the PUD 70 can retrieve such event data from such databases via communication link 82 and network 80 (shown in FIG. 17). For instance, the PUD 70 can establish a communication session with National Weather Service databases, National Oceanic and Atmospheric Administration databases, or any other source capable of providing weather data over the communication link 82 and network 80. The PUD 70 can then query and retrieve event data such as ambient pressure, air temperature, tide level, moon-phase, water temperature, and wind conditions for the geographic location of the PUD 70 or controller 50.

The event record can be updated or overwritten (Step 145) periodically (or continuously) with the event data received from the controller 50 or network 80 (NO at Step 150) until a catch event is detected (YES at Step 150). The event record can be updated to store historical event data for the duration of the tracking event (initiated at Step 105). The number of historical event data points can be adjusted to depend on the storage requirements of the PUD 70.

If a catch event is detected (YES at Step 150), then the event record can be updated with a catch event flag to indicate a catch event and the record can be updated with event data associated with the catch event and the time of the catch event (Step 155). The PUD 70 can generate and display screen 70B, including certain of the event data, such as, for example, the weight of the object (e.g., 141bs), the date and time the weight of the object was sensed, the image of the catch, and the weather and water conditions at the time of the weighing (Step 160).

The smart net process can include an additional step (not shown) to prompt the user to take a photo using a camera (not shown) on the PUD 70 and store the photo in the event record. This way the user can have a photo of the catch saved with the event data in the event record.

Referring to FIG. 20, PUD 70 display screens 70D, 70E, and 70F show examples of photos that can be taken together with associated catch events. Display screen 70D includes two separate catch events, including a photo of the user with a first object (a fish, and more specifically a trout fish) in a first catch event (shown in the upper portion of the screen 70D) and a photo of the user with a second object (another fish, and more specifically a small mouth bass fish) in a second catch event (shown in the lower portion of the screen 70D). Display screen 70E shows examples of photos that can be taken of places where catch events occurred, such as, for example, a river in South Haven or a lake in Frankfort. The display screen 70F shows map data associated with the catch event shown in the upper portion of display screen 70D.

The smart net process can include an additional step (not shown) of displaying a CATCH RELEASE screen 70C (shown FIG. 19) to prompt the user to release the object from the basket 20. As seen, the display screen can include a radio button for the user to select after releasing the object (fish), thereby completing the event record. This step can be included to allow the user to set one or more alerts when to release the fish back into the water.

The catch event can be detected (Step 150) based on a catch event signal received from the controller 50. The catch event signal can include an object weight signal generated by the controller 50 based on the weight signal the controller 50 received from the strain sensor interface 53 (shown in FIG. 15). The controller 50 can initiate generation and transmission of the catch event signal to the PUD 70 when a determination is made that an object is received in the basket 20. The determination can be based on a change in the weight signal from the strain sensor interface 53 exceeding a predetermined weight threshold W_{T}, such as, for example, four ounces (4 oz.)—that is, when the controller 50 receives a weight signal that indicates a measured weight greater than W_{T}, the controller 50 generates and transmits the catch event signal to the PUD 70 via the network interface 65 (shown in FIG. 15). The weight threshold W_{T} can be set to a weight value greater or less than four ounces. The received catch event signal can include an event data signal that includes one or more types of data related to conditions surrounding the catch event, such as, for example, water temperature data, air temperature data, or atmospheric pressure data.

Continuing to refer to FIGS. 17-20, upon initiation of the smart net process on the PUD 70 (Step 100) and display of the main menu (Step 105), a past event screen 70D (shown in FIG. 20) can be displayed on the PUD 70 (PAST EVENT at Step 105, then Step 110). The past event screen 70D (Step 110) can include a display of a library of catch event records stored in the PUD 70 (or database 85, shown in FIG. 17). The past event screen 70D can show the stored catch event records as a list or as a series of preview catch event record highlights such as, for example, species of fish, geographic location, photo, object weight, date, time, water conditions, or weather conditions.

The user can be permitted to select a particular catch event record for editing. For instance, the user can select on the past event screen 70D to select a particular catch event record. When the user selects the particular catch event record from the displayed library (Step 110), the PUD 70 receives the associated command signal, including the user selection (Step 115). One or more catch event records can be retrieved and displayed based on the user selection. Referring to FIG. 20, the PUD 70 can display the screen 70F, which includes a selected catch event record. As seen in screen 70F, the displayed catch event record can include a map associated with the catch event, a photo of the catch event, and data associated with the catch event, including species of fish, or weight of fish.

The user can be prompted regarding whether s/he wishes to edit the selected catch event record (Step 120). Instead of being prompted, the user can select an edit feature from the main menu (Step 120). If the user selects an edit option (YES at Step 120), then the user can be provided with one or more options for editing the catch event record and the catch event record can be edited accordingly (Step 125). The edit option can include, for example, a record delete option, a record update option, a photo include or add option, or a note or comment add option.

If, however, the user elects not to edit the catch event record (NO at Step 120), then the edit option screen (not shown) can be removed and the display screen reverted to the catch event record screen 70F.

Still referring to FIGS. 17-20, upon initiation of the smart net process on the PUD 70 (Step 100) and display of the main menu (Step 105), the PUD 70 can display a search field or a user prompt (not shown) to allow the user to enter one or more search terms (Step 165). The search terms are received (Step 165) and used to query stored catch event records in the PUD 70 or database 85 (Step 170). One or more catch event records can be retrieved and displayed based on the search term(s) (Step 175). Screen 70D shows an example of an event record that can be retrieved. Searches of stored catch event records can be carried out based on, for example, species of fish, geographic location, fish weight, date, time, water conditions, or weather conditions.

The user can be prompted regarding whether s/he wishes to edit displayed catch event record (Step 180). Instead of being prompted, the user can select an edit feature from the main menu (Step 180). If the user selects an edit option (YES at Step 180), then the user can be provided with one or more options for editing the catch event record and the catch event record can be edited accordingly (Step 185). The edit option can include, for example, a record delete option, a record update option, a photo include or add option, or a note or comment add option.

If, however, the user elects not to edit the catch event record (NO at Step 180), then the display screen can revert or continue to display the catch event record screen, such as, for example, screen 70F in FIG. 20 (Step 190).

The terms “a,” “an,” and “the,” as used in this disclosure, means “one or more,” unless expressly specified otherwise.

The term “communication(s) link,” as used in this disclosure, means a wired and/or wireless medium that conveys data or information between at least two points. The wired or wireless medium can include, for example, a metallic conductor link, a radio frequency (RF) communication link, an Infrared (IR) communication link, an optical communication link, or the like, without limitation. The RF communication link can include, for example, WiFi, WiMAX, IEEE 802.11, DECT, 0G, 1G, 2G, 3G, 4G or 5G cellular standards, Bluetooth, or the like. A communication(s) link can include a public switched telephone network (PSTN) line, a voice-over-Internet-Protocol (VoIP) line, a cellular network link, an Internet protocol link, or the like. The Internet protocol can include an application layer (e.g., BGP, DHCP, DNS, FTP, HTTP, IMAP, LDAP, MGCP, NNTP, NTP, POP, ONC/RPC, RTP, RTSP, RIP, SIP, SMTP, SNMP, SSH, Telnet, TLS/SSL, XMPP, or the like), a transport layer (e.g., TCP, UDP, DCCP, SCTP, RSVP, or the like), an Internet layer (e.g., IPv4, IPv6, ICMP, ICMPv6, ECN, IGMP, IPsec, or the like), and a link layer (e.g., ARP, NDP, OSPF, Tunnels (L2TP), PPP, MAC (Ethernet, DSL, ISDN, FDDI, or the like), or the like).

The term “computer,” as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, a server farm, a computer cloud, or the like, or an array of processors, microprocessors, central processing units, general purpose computers, super computers, personal computers, laptop computers, palmtop computers, notebook computers, desktop computers, workstation computers, servers, server farms, computer clouds, or the like.

The term “computer-readable medium,” as used in this disclosure, means any medium that participates in providing data (for example, instructions) which may be read by a computer. Such a medium may take many forms, including non-volatile media, volatile media, and transmission media. Non-volatile media may include, for example, optical or magnetic disks and other persistent memory. Volatile media may include dynamic random access memory (DRAM). Transmission media ay include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, RAM, PROM, EPROM, FLASH-EEPROM, or any other memory chip or cartridge, or any other medium from which a computer can read.

The term “database,” as used in this disclosure, means any combination of software and/or hardware, including at least one application and/or at least one computer. The database may include a structured collection of records or data organized according to a database model, such as, for example, but not limited to at least one of a relational model, a hierarchical model, a network model or the like. The database may include a database management system application (DBMS) as is known in the art. The at least one application may include, but is not limited to, for example, an application program that can accept connections to service requests from clients by sending back responses to the clients. The database may be configured to run the at least one application, often under heavy workloads, unattended, for extended periods of time with minimal human direction.

The term “fastener,” as used in this disclosure, means an adhesive, an adhesive or fusion process, a screw, a bolt, a nut, a rivet, a pin, a hook, a loop, a tongue-and-groove, hook-and-loop (e.g., Velcro®), or the like.

The terms “including,” “comprising,” and variations thereof, as used in this disclosure, mean “including, but not limited to,” unless expressly specified otherwise.

The term “network,” as used in this disclosure means, but is not limited to, for example, at least one of a local area network (LAN), a wide area network (WAN), a metropolitan area network (MAN), a personal area network (PAN), a campus area network, a corporate area network, a global area network (GAN), a broadband area network (BAN), a cellular network, the Internet, or the like, or any combination of the foregoing, any of which can be configured to communicate data via a wireless and/or a wired communication medium. These networks can run a variety of protocols not limited to TCP/IP, IRC or HTTP.

The term “smart device,” as used in this disclosure, means an electronic device or computer that can be connected to other devices or computers via a communication link and that can operate to some extent interactively and autonomously.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single structure or article is described herein, it will be readily apparent that more than one device or article may be used in place of a single device or article. Similarly, where more than one device or article is described herein, it will be readily apparent that a single structure or article may be used in place of the more than one structure or article. The functionality or the features of a structure or article may be alternatively embodied by one or more other structures or articles that are not explicitly described as having such functionality or feature.

While the disclosure has been described in terms of exemplary embodiments, those skilled in the art will recognize that the disclosure can be practiced with modifications in the spirit and scope of the instant disclosure. These examples given above are merely illustrative and are not meant to be an exhaustive list of all possible designs, embodiments, applications or modifications of the disclosure.

LIST OF ELEMENTS

| | |
|---|---|
| 1 | hand net device |
| 10 | yoke device |
| 11 | yoke body |
| 12 | grip |
| 13 | yoke module |
| 14 | actuator |
| 15 | snap button assembly |
| 18 | housing |
| 20 | basket |
| 21 | hoop |
| 22 | net |
| 30 | handle |
| 50 | controller |
| 51 | system bus |
| 52 | position sensor |
| 53 | strain sensor interface |
| 54 | illumination driver |
| 55 | ambient sensor interface |
| 60 | microcontroller |
| 61 | processor |
| 62 | memory storage |
| 63 | hard drive |
| 65 | network interface |
| 66 | I/O interface |
| 110 | lower body portion of yoke body |
| 111 | upper body portion of yoke body |
| 112 | bridge portion |
| 113 | cutout for hoop receptacle |
| 114 | chamber |
| 115 | module receptacle recess (or recess) |
| 117 | fastener |
| 118 | groove |
| 119 | housing |
| 121 | portion of grip |
| 128 | cutouts for grip portion |
| 129 | grip receptacle |
| 151 | handle lock |
| 153 | spring mechanism |
| 155 | lock actuator |
| 158 | lock fastener |
| 211 | hoop receptacle |
| 311 | handle receptacle |
| 312 | pass-through opening |
| 313 | channel |
| 621 | ROM |
| 622 | RAM |
| 1141 | load sensor |
| 1311 | display |
| 1312 | tongue |
| 1313 | grip receiver |

What is claimed is:

1. A hand net device, comprising:
a yoke device having a yoke body;
a basket attached to the yoke body, the basket including
a net that holds an object and
a hoop that attaches to the net; and
a handle attached to the yoke body.

2. The hand net device of claim 1, further comprising:
a load sensor that generates a weight signal that is proportional to a weight of an object in the basket.

3. The hand net device of claim 2, wherein the load sensor is located in or on at least one of the yoke device, the basket, the hoop and the handle.

4. The hand net device of claim 1, further comprising at least one of:
a water temperature sensor;
an ambient temperature sensor; and
an atmospheric pressure sensor.

5. The hand net device of claim 1, further comprising:
a GPS receiver.

6. The hand net device of claim 1, further comprising:
an actuator.

7. The hand net device of claim 1, further comprising:
a light emitting element (LEE).

8. The hand net device of claim 7, wherein the light emitting element comprises a light emitting diode (LED).

9. The hand net device of claim 1, further comprising:
an illuminator that generates and directs a light beam toward the basket.

10. The hand net device of claim 1, wherein the hoop has a reflective finish.

11. The hand net device of claim 1, wherein yoke device includes a snap button assembly.

12. The hand net device of claim 1, wherein the yoke device is hermetically sealed.

13. The hand net device of claim 1, wherein the yoke body is adapted to receive and securely hold a yoke module.

14. The hand net device of claim 13, wherein the yoke body comprises a module receptacle recess that matches at least one of a size or a shape of the yoke module.

15. The hand net device of claim 13, wherein the yoke module comprises:
a blank module;
an illumination module;
a smart module; or
a smart module with illumination.

16. The hand net device of claim 1, further comprising:
a hand grip that is movable between a collapsed configuration and a deployed configuration.

17. The hand net device of claim 1, wherein the yoke device comprises a snap button assembly that includes a lock actuator and a handle lock.

18. The hand net device of claim 17, wherein the snap button assembly further comprises a spring mechanism that keeps the handle lock in a lock position until sufficient force is applied to the spring mechanism to allow the handle lock to move from the lock position.

19. A hand net device, comprising:
a yoke device having a yoke body that includes a lock actuator;
a basket that includes a net that holds an object and a hoop that attaches to the net;
a handle attached to the yoke body; and
a load sensor that generates a weight signal that is proportional to a weight of an object in the basket.

20. A hand net device, comprising:
a yoke device having a yoke body that includes a lock actuator;
a basket that includes a net that holds an object and a hoop that attaches to the net; and
a hand grip that is movable between a collapsed configuration and a deployed configuration,
wherein the yoke device includes a yoke module having a blank module, an illumination module, a smart module, or a smart module with illumination.
